(19) United States
(12) Patent Application Publication
(10) Pub. No.: US 2003/0223140 A1
(43) Pub. Date: Dec. 4, 2003

(54) Recording device and recording method

(75) Inventors: Hiroshi Kobata, Yokohama-shi (JP); Yuji Miyashita, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/427,914

(22) Filed: May 2, 2003

(30) Foreign Application Priority Data
May 31, 2002 (JP) 2002-160754

(51) Int. Cl. G11B 5/86

(52) U.S. Cl. 360/15

(57) ABSTRACT

Upon receiving from a content size comparison section that the total data size of contents specified by a user is larger the free storage space of a recording medium, a specified size recording section instructs a transfer control section to record the specified contents onto a plurality of recording mediums in units of contents on the basis of content management information stored in a management information storage section and the free storage space of the recording medium detected by a free storage space detection section.

### CROSS-REFERENCE TO THE RELATED APPLICATIONS

This application is based upon and claims the benefit of priority from the prior Japanese Patent Application No. 2002-160754, filed May 31, 2002, the entire contents of which are incorporated herein by reference.

### BACKGROUND OF THE INVENTION

1. Field of the Invention

The present invention relates to a recording/reproducing device which has a plurality of recording/reproducing units and transfers/copies contents, such as video and associated audio, from a recording medium of a first recording/reproducing unit onto a recording medium of a second recording/reproducing unit.

2. Description of the Related Art

In recent years, devices have began to come into wide use, which are equipped with a plurality of recording/reproducing units, such as optical disk drives, hard disk drives (HDD), or the like. The optical disk drives records contents, such as MPEG-compressed video and associated audio, onto a recordable optical disk, such as a DVD (Digital Versatile Disk)-RAM. The hard disk drives record such contents onto a hard disk.

In general, such recording/reproducing devices can transfer or copy contents from the hard disk in the HDD to the optical disk in the optical disk drive and vice versa.

With a recording/reproducing device equipped with an HDD and an optical disk drive, after reservation recording two or more contents such as broadcast programs onto the hard disk, in order to transfer the contents items recorded on a hard disk onto an optical disk such as a DVD-RAM, the user is required to specify the contents one by one. Namely, after the completion of transfer of one content, the user must specify the next content to be transferred/copied onto the optical disk. That is, with the conventional recording/reproducing devices to record MPEG-compressed data, it is impossible to specify two or more contents recorded on the hard disk at a time for transfer onto the optical disk.

In addition, trying to transfer/copy a content recorded on the hard disk to an unused recordable optical disk loaded into the optical disk drive results in failure to record it if its data size is larger than the storage capacity of that optical disk.

In such a case, the user is required to divide the content into sections and record them onto two or more optical disks. That is, the user is required to examine the available storage space of each of the optical disks and specify content sections on the hard disk to suit the free storage space of each of the optical disks. One content section is recorded onto a first disk and another content section is recorded on a second disk. In such a case, therefore, the operation of the recording/reproducing device becomes very troublesome. Such a problem will also arise when the size of a specified content is beyond the amount of free storage space of an optical disk which has data recorded to some extent. Japanese Unexamined Patent Publication 2001-344877 discloses a recording/reproducing device which records a content, such as a broadcast program, onto an optical disk in real time. In this publication, an information recording device is disclosed which, when the remaining storage space of an optical disk becomes reduced during the recording of a content, requests the user to replace that disk with another one while a portion of a video sequence being broadcast, such as commercial video, that the user does not care if it has dropped out is being broadcast. The request for disk replacement is generated at a time when a change in the stereophonic/monophonic audio mode, an abrupt change of audio data, or an abrupt change of video data is detected.

A prerequisite to the technique disclosed in that publication is the presence of data that the user does not care if it has dropped out. In the absence of such data, there is the possibility that important information cannot be recorded. It is possible to store temporarily data when the disk is being replaced on a hard disk. However, when the hard disk has little free storage space, the drop-out of the data will occur.

### BRIEF SUMMARY OF THE INVENTION

A recording device according to one aspect of the present invention comprises: a first recording unit; a second recording unit; a transfer control section which controls a transferring operation of content data from the first recording unit to the second recording unit, the transferring operation including copying of the content data; a free storage space detection section which detects and stores a free storage space of a recording medium in the second recording unit; a size comparison section which, in specifying and transferring a plurality of contents from the first recording unit to the second recording unit, makes a comparison between a total data size of specified contents and the free storage space of the recording medium detected by the free storage space detection section; and an instruction section which, when receiving from the size comparison section that the total data size of the specified contents is larger than the free storage space of the recording medium, instructs the transfer control section to record the specified contents onto a plurality of recording mediums in units of contents.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a recording/reproducing device to which the present invention is applied;

FIG. 2 illustrates the directory structure of real-time recording DVD-VR standard video and audio files applied to the recording/reproducing device shown in FIG. 1;

FIG. 3 illustrates the structures of the movie video file and the still-picture video file of FIG. 2;

FIG. 4 illustrates a functional diagram of a recording/reproducing device according to a first embodiment of the present invention;

FIG. 5 illustrates a functional diagram of a recording/reproducing device according to a second embodiment of the present invention;

FIG. 6 illustrates a functional diagram of a recording/reproducing device according to a third embodiment of the present invention; and

FIG. 7 is a flowchart illustrating the operation of the operation selective instructing section 301 in FIG. 6.

### DETAILED DESCRIPTION OF THE INVENTION

The embodiments of the present invention will be described in detail below with reference to the accompanying drawings. It should be noted that the embodiments described below are illustrative and not restrictive.

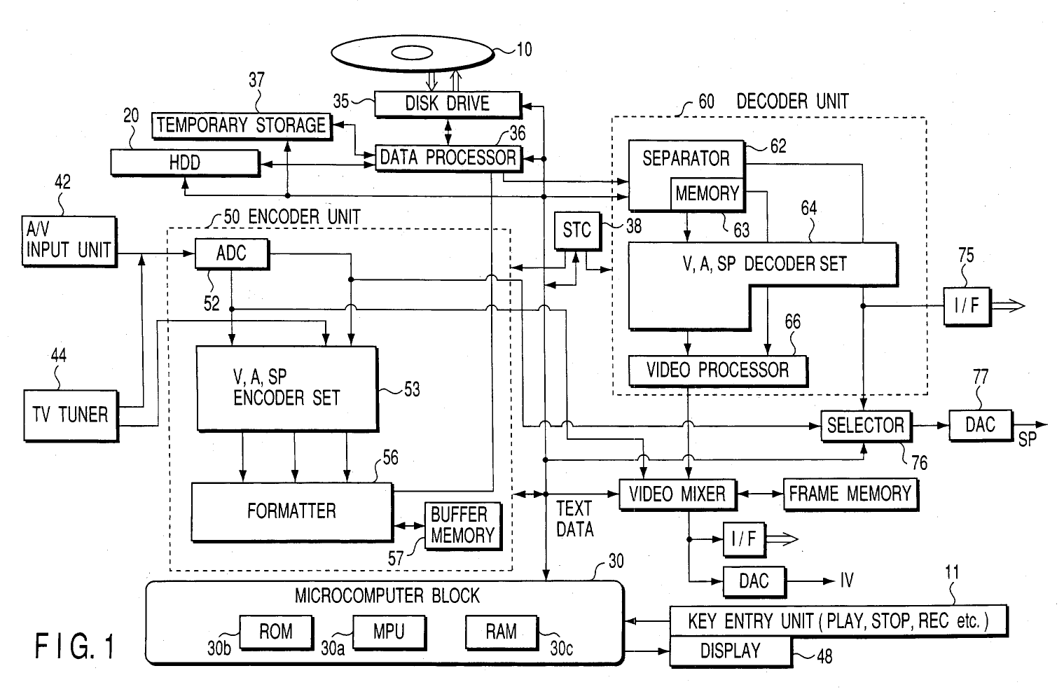

FIG. 1 is a block diagram of a recording/reproducing device to which the present invention is adapted. This recording/reproducing device is constructed mainly from a hard disk drive (HDD) 20, a disk drive 35, an encoder unit 50 forming an recording end, a decoder unit 60 forming a reproducing end, and a microcomputer block 30 that controls the operation of the device. The disk drive 35 is adapted to drive an optical disk 10 that is an information storage medium capable of recording video files and read from or write onto that optical disk.

The encoder unit 50 is equipped with an analog-to-digital converter (ADC) 52, a encoder set 35 including a video (V) encoder, an audio (A) encoder, and a sub-picture (SP) encoder, a formatter 56 that provides the output of each of the encoders in a predetermined format, and a buffer memory 57.

The ADC 52 receives external analog video and audio signals from an AV input unit 42 or analog TV picture and sound signals from a television (TV) tuner 44.

A data processor 36, under the control of the microcomputer block 30, provides DVD-recorded data output from the encoder unit 50 to the disk drive 35, receives DVD signals from the disk drive 35 which have been reproduced from the optical disk 10, rewrites management information recorded on the optical disk 10, and erases data recorded on the optical disk 10.

The microcomputer block 30 includes a microprocessor unit (MPU) 30a, a ROM 30b written with control programs, and a RAM 30c for providing a work area for program execution.

The MPU 30a carries out editing, defective location detection, unrecorded area detection, video information recording location setup, UDF recording, AV address setup, etc in accordance with a control program according to the present invention stored in the ROM30b.

The decoder unit 60 comprises a separator 62, a memory 63, a decoder set 64 comprising a V decoder, an SP decoder, and an A decoder, and a video processor 66. The separator 62 separates and takes out each pack from video information having a pack structure. The memory 63 is used for pack separation and other signal processing. The V decoder decodes main video data separated by the separator 62. The SP decoder decodes sub-picture information separated by the separator 62. The A decoder decodes audio data separated by the separator 62. The video processor 66 suitably combines the main video data from the V decoder and the sub-picture data from the SP decoder to output superimposed video in which sub-picture such as a menu, titles/subtitles, etc., is superimposed on main video.

To provide the A decoder output in a digital form, it is output as it is to outside through an interface (I/F) 75. To provide the A decoder output in an analog form, it is fed through a selector 76 into a DAC 77 for conversion into an analog form and then output to outside. The selector 76 selects either of an input signal from the ADC 52 and an input signal from the decoder set 64. The analog audio signal is applied to an external component not shown (a multichannel (two to six channels) stereo system).

A key entry unit 11 is provided with keys labeled PLAY (playback), STOP, REC (recording), SKIP, FF (fast forward), REW (rewind), SLOW, etc. By selectively pressing these keys, the user is allowed to operate the recording/reproducing device: recording material onto the HDD 20 or the optical disk 10, playing back the recorded material, or transferring (copying) material recorded on the HDD to the optical disk.

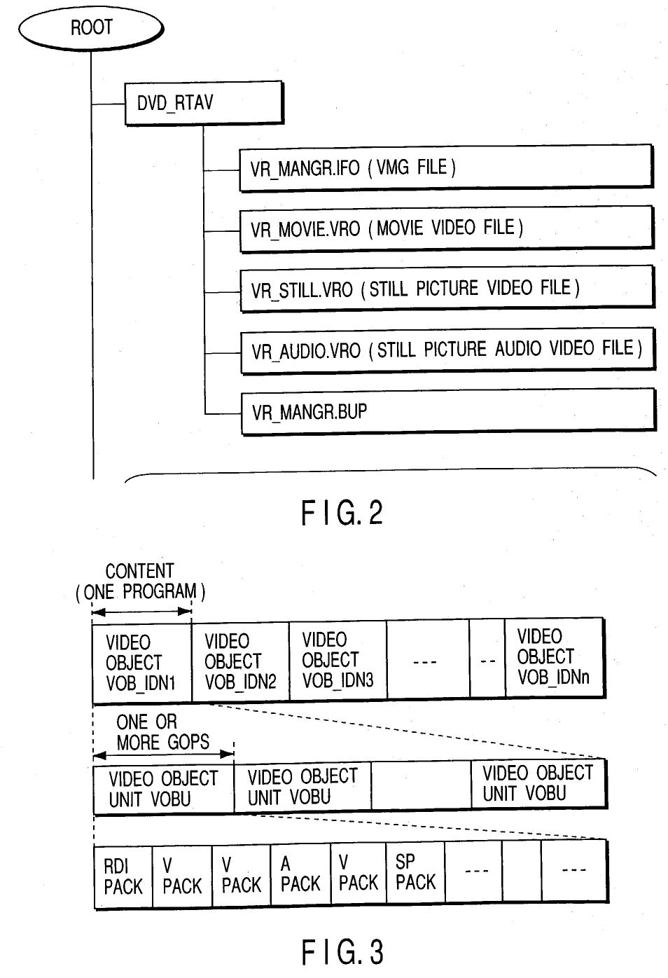

FIG. 2 illustrates a example of the directory structure of video and audio files that conform to the real-time recording DVD-VR standard adopted to the disk applied to the recording/reproducing device of FIG. 1.

With DVDs, a directory exists for each standard. The names of directories are “DVD_RTAV” for DVD_VR, “AUDIO_TS” for DVD-audio, and “VIDEO_TS” for DVD-video. FIG. 2 shows the DVD_RTAV. Recorded data is present within each directory. With DVDs, data is retained in a usual file format. A title corresponds to one motion picture, for example. One disk is capable of two or more titles.

The directory “DVD_RTAV” contains VR_MANGR. IFO as a video manager (VMG) file, VR_MOVIE. VRO as a movie video file, VR_STILL. VRO as a still picture video file, VR_AUDIO. VRO as a still picture audio file, and VR_MANGR. BUP as a backup of the video manager.

The VR_MANGR. IFO file is recorded with navigation data, which proceed with a program set, programs, entry points, and a play list.

The VR_MOVIE. VRO file is what is called the movie-AV file for recording a movie video object (movie-VOB).

The VR_STILL. VRO file is a still picture AV file for recording a still picture-VOB. This VR_STILL. VRO file is used to record an original VOB formed of video parts containing arbitrary sub-picture units. Audio parts related to the video parts are also contained in the original VOB.

The VR_AUDIO. VRO file is a still-picture added audio file for recording an audio stream to be added to a still picture. The added audio part indicates an audio stream recorded by after recording. The audio part recorded in the VR_AUDIO. VRO file is used combined with several video parts recorded in the VR STILL. VRO file.

FIG. 3 shows the structures of the VR_MOVIE. VRO as the movie video file and the VR_STILL. VRO as the still picture video file.

The video file is hierarchically structured and composed of two or more VOBs (video objects). One VOB is composed two or more VOBUs (video object units) and one VOBU is composed of two or more packs. Packs include V packs and A packs.

The V packs are MPEG2-compressed video data. The A packs are linear-PCM-, MPEG-, or AC3-processed audio data. The pack is tagged with a time stamp such as a presentation time stamp (PTS) indicating a playback time and a decoding time stamp (DTS) indicating a decode time. The playback is performed according to the times indicated by such time stamps.

One video object (VOB) corresponds to, for example, one movie program. The playback time of one video object unit (VOBU) corresponds usually to that of video data formed of one or more video groups (GOPs: groups of pictures) contained in it. Usually, the MPEG2 standard defines about 0.5 seconds for one GOP. Compressed video data is contained within one GOP so that about 15 frames of video will be reproduced during that time.

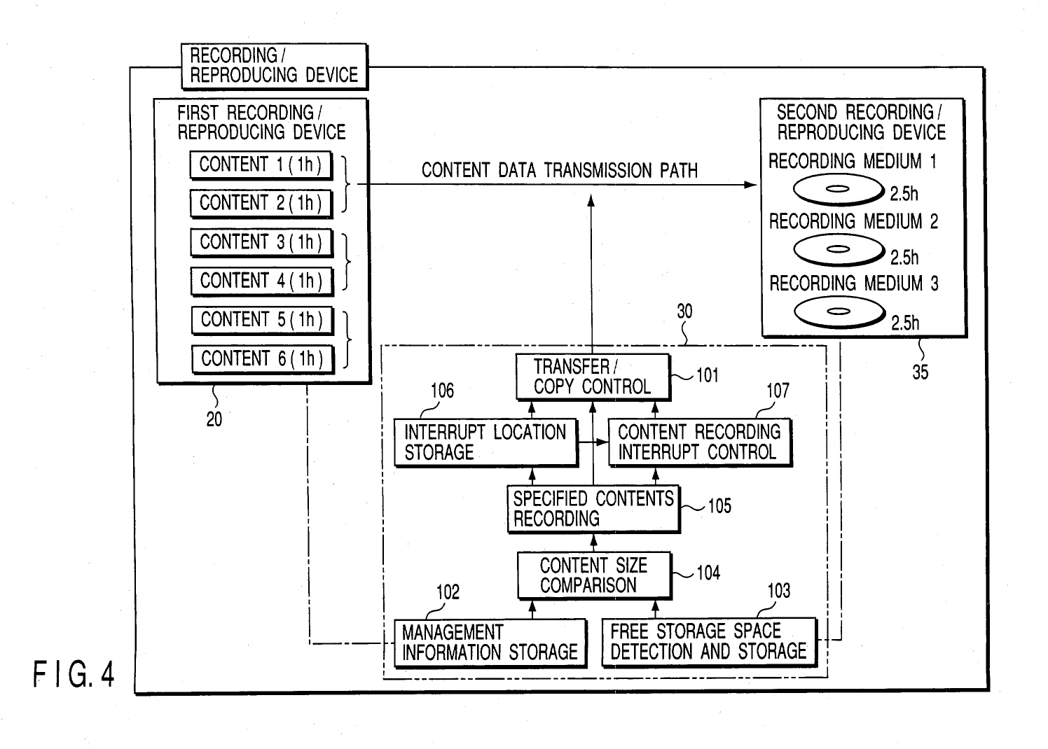

As described above, one video object (VOB) is composed of two or more video object units and each video object unit forms the smallest element of one video object. In the present embodiment, one video object will be described as one content FIG. 4 illustrates a functional diagram of a recording/reproducing device according to a first embodiment of the present invention.

This system is a recording/reproducing system which has n recording/reproducing units and transfers two or more contents from a first recording/reproducing unit 20 to a second recording/reproducing unit 35. The first recording/reproducing unit 20 is, for example, an HDD and the second recording/reproducing unit 35 is, for example, a DVD disk player.

A transfer/copy control section 101 controls the transfer or copy (hereinafter referred to as transfer/copy) of content data from the first recording/reproducing unit 20 to the second recording/reproducing unit 35. A management information storage section 102 stores management information, such as the time and date of recording, the data size, the record location, etc., for each of the contents contained in the first recording/reproducing unit 20.

A free space detection and storage section 103 detects and stores the free storage space of a recording medium in the second recording/reproducing unit 35. A content size comparison section 104 makes a comparison between the total data size of two or more contents to be transferred/copied from the first recording/reproducing unit 20 to the second recording/reproducing unit 35 and the free storage space of that recording medium in the second recording/reproducing unit 35 detected by the free storage space detection and storage section 103.

A specified content recording section 105, when receiving notification from the content size comparison section 104 that the total data size of two or more contents to be transferred/copied is larger than the free storage space of the recording medium in the second recording/reproducing unit 35, records the contents without separating each content into two or more parts. That is, the specified contents recording section 105 divides two or more contents specified by the user in units of contents, determines a maximum number of contents the data size of which is less than or equal to the free space of the recording medium, and instructs the transfer and copy control section 101 to transfer/copy the maximum number of contents to the second recording/reproducing unit 35.

An interrupt location storage section 106 stores the management information and the interrupt location of a content the transfer/copy of which has been interrupted by the specified contents recording section 105. When the recording medium in the second recording/reproducing unit 35 is replaced, a content recording interruption control section 107 resumes the transfer/copy of that content at its interrupt location stored in the interrupt location storage section 106.

The functional blocks 101 to 107 can be implemented in the form of a control program within the ROM 30b of the microcomputer block 30 of FIG. 1. The MPU 30c runs the control program to effect the transfer/copy of contents according to the present invention.

Hereinafter, the operation of the first embodiment will be described by way of an example of transferring or copying six contents each containing one hour of video data from the first recording/reproducing unit 20 to the second recording/reproducing unit 35. Suppose that a recording medium (for example, a DVD-RAM) loaded into the second recording/reproducing unit 35 can store up to 2.5 hours of video data.

First, the content size comparison section 104 makes a comparison between the data size (corresponding to one hour of data) of content 1 stored in the management information storage section 102 and the free space (corresponding to 2.5 hours of data) of recording medium 1 stored in the free space detection and storage section 103 and presents the result to the specified contents recording section 105. In this case, the comparison section 104 notifies the recording section 105 that the data size of content 1 is less than the free storage space of recording medium 1.

The recording section 105 then instructs the control section 101 to transfer/copy that content. As a result, the control section 101 transfers/copies content 1 from the first recording/reproducing unit 20 to the second recording/reproducing unit 35.

Next, the comparison section 104 makes a comparison between the data size (one hour) of content 2 and the free storage space (1.5 hours because content 1 has been already recorded) of recording medium 1 and then notifies the recording section 105 that the data size of content 2 is less than the free storage space of recording medium 1. The recording section 105 then instructs the control section 101 to transfer/copy that content. As a result, the control section 101 transfers/copies content 2 from the first recording/reproducing unit 20 to the second recording/reproducing unit 35.

Next, the comparison section 104 makes a comparison between the data size (one hour) of content 3 and the free storage space (0.5 hours because content 1 and content 2 have been already recorded) of recording medium 1 and presents the result to the recording section 105. In this case, since the data size of content 3 is greater than the free storage space of recording medium 1, the transfer/copy of content 3 is not carried out by the recording section 105.

The content recording interrupt control section 107 sends an instruction to exchange the recording medium to the display unit 48 or an external display unit connected to the recording/reproducing device. The interrupt location storage section 106 stores management information associated with content 2 in the first recording/reproducing unit 20, for example, the location at which the final data of content 2 is recorded or the location at which the first data of content 2 is recorded (the location at which the next transfer/copy operation is started). Thus, content 3 is set up as an object to be transferred/copied next.

When the user replaces recording medium 1 with recording medium 2 in the second recording/reproducing unit as instructed by the recording/reproducing device, the recording medium's free space stored in the free space detection and storage section 103 is restored to 2.5 hours of data.

The content size comparison section 104 makes a comparison between the amount of data of content 3 (corresponding to one hour of data) and the free space of recording medium 2 (corresponding to 2.5 hours of data) and notifies the recording section 105 that the data size of content 3 is less than the free space of recording medium 2. The recording section 105 then instructs the control section 101 to transfer/copy that content. As a result, the control section 101 starts transferring/copying content 3 on the basis of information stored in the storage section 106.

After that, the above operations are repeated to transfer/copy content 3 onto recording medium 2 on which content 2 has already been recorded. In the same way, contents 5 and 6 are transferred/copied onto recording medium 3.

To date, it has been unable to specify two or more contents for transfer/copy of video data. Further, it has been unable to specify contents the total amount of data of which is beyond the storage capacity of a recording medium and transfer/copy the contents to that recording medium. According to the present invention, however, even in such a case it is possible to transfer/copy two or more contents in succession.

With the first embodiment, in transferring/copying contents 1 to 6 each with a relatively long time of video data from the HDD 20 to the DVD disk drive 35, each content is recorded continuously onto a recording medium. That is, one content will not be recorded across two recording mediums.

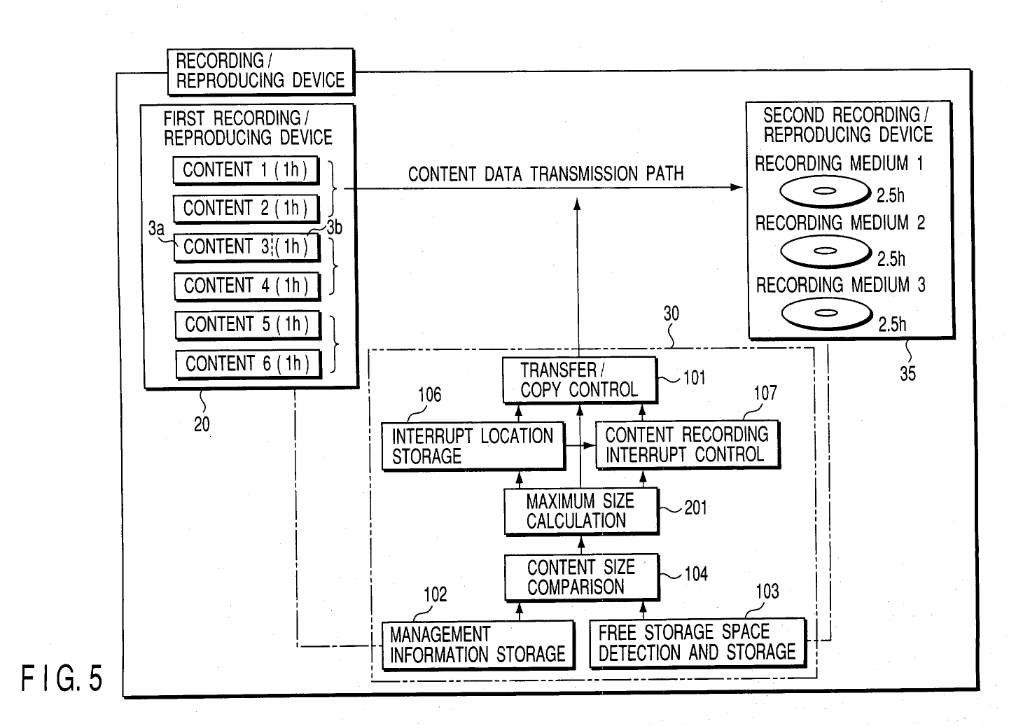

A second embodiment of the present invention will be described next with reference to FIG. 5, which is a functional block diagram of a recording/reproducing device according to the second embodiment.

The transfer and copy control section 101 controls the transfer or copy of content data from the first recording/reproducing unit 20 to the second recording/reproducing unit 35. The management information storage section 102 stores management information, such as the time and date of recording, the data size, the record location, etc., for each of the contents recorded on the first recording/reproducing unit 20.

The free space detection and storage section 103 detects and stores the free space of a recording medium in the second recording/reproducing unit 35. The content size comparison section 104 makes a comparison between the total data size of two or more contents to be transferred/copied from the first recording/reproducing unit 20 to the second recording/reproducing unit 35 and the free space of that recording medium in the second recording/reproducing unit 35 detected by the free space detection and storage section 103.

In response to notification from the content size comparison section 104 that the total amount of data of content to be transferred/copied is greater than the storage capacity of a recording medium in the second recording/reproducing unit 35, a maximum size calculation section 201 separates the content into sections below the storage capacity of the recording medium even in the middle of a content. A section below the storage capacity of the recording medium is transferred and copied onto the recording medium. At this point, the separation is performed in minimum units in which the content can be divided, e.g., on a VOBU-by-VOBU basis. The content is separated so that the section to be transferred onto the recording medium will have a maximum amount of data within the storage capacity of the recording medium.

The interrupt location storage section 106 stores the management information and the interrupt location of a content the transfer/copy of which has been interrupted by the maximum size calculation section 201. When the recording medium in the second recording/reproducing unit 35 is replaced, the content recording interruption control section 107 resumes the transfer/copy of that content at its interrupt location stored in the interrupt location storage section 106.

Hereinafter, the operation of the second embodiment will be described. In this embodiment as well, the first recording/reproducing unit 20 contains six contents each of one hour of video data and they are transferred/copied onto recording mediums in the second recording/reproducing unit. Each of the recording mediums can store up to 2.5 hours of video data.

First, the content size comparison section 104 makes a comparison between the data size (corresponding to one hour of video data) of content 1 stored in the management information storage section 102 and the free space (corresponding to 2.5 hours of video data) of recording medium 1 stored in the free space detection and storage section 103 and presents the result to the maximum size calculation section 201.

The maximum size calculation section 201 instructs the transfer/copy control section 101 to transfer/copy content 1. The transfer/copy control section 101 then transfers/copies content 1 onto recording medium 1 in the second recording/reproducing unit.

Next, the comparison section 104 makes a comparison between the data size (one hour) of content 2 and the free space (1.5 hours because content 1 has been already recorded) of recording medium 1. Thus, content 2 is transferred/copied onto recording medium 1 as is the case with content 1.

Next, the comparison section 104 makes a comparison between the data size (one hour) of content 3 and the free space (0.5 hours) of recording medium 1 and presents the result to the maximum size calculation section 201. In this case, the data size of content 3 is greater than the free space of recording medium 1. The maximum size calculation section 201 then calculates the location at which content 3 is separated into content 3a and content 3b in such a way that the size of content 3a becomes maximum in units of VOBUs within the free space (0.5 hours) of recording medium 1. In this example, content 3 is reorganized into two VOBs each containing 0.5 hours of video data. After that, the maximum size calculation section 201 instructs the transfer/copy control section 101 to transfer/copy content 3a onto recording medium 1.

After content 3a has been transferred/copied onto recording medium 1, the content recording interrupt control section 107 sends an instruction to exchange the recording medium to the display unit 48 or an external display unit connected to the recording/reproducing device. The interrupt location storage section 106 stores the location at which the final VOBU of content 3a is recorded or the location at which the first VOBU of content 3b is recorded (the location at which the next transfer/copy operation is started) in the first recording/reproducing unit. Thus, content 3b is set up as an object to be transferred/copied next.

When the user, as instructed, replaces recording medium 1 with recording medium 2 in the second recording/reproducing unit, the recording medium's free space stored in the free space detection and storage section 103 is changed to 2.5 hours.

The content size comparison section 104 makes a comparison between the amount of data of content 3b (one hour of video data) and the free space of recording medium 2 (corresponding to 2.5 hours of video data) and notifies the recording section 105 that the data size of content 3b is less than the free space of recording medium 2.

The maximum size calculation section 201 then instructs the transfer/copy control section 101 to transfer/copy content 3b. As a result, the control section 101 starts transferring/copying content 3b on the basis of information stored in the storage section 106.

After that, the above operations are repeated to transfer/copy contents 4 and 5 onto recording medium 2. The transfer/copy of content 6 is not carried out until recording medium 2 has been replaced with recording medium 3 because recording medium 2 has no storage space to store content 6.

As described above, in transferring/copying contents 1 to 6 each with a relatively long time of video data from the HDD 20 to the DVD disk drive 35, the second embodiment makes the most use of the storage capacity of a recording medium in units of VOBUs. That is, when the size of a content to be recorded is beyond the free space of a recording medium, that content is separated into first and second sections so that the first section to be recorded on that recording medium will have a maximum size in units of VOBUs within the free space of the recording medium. The first content section is recorded on the recording medium and the second content section is recorded on another recording medium. That is, the content to be separated is recorded continuously onto two recording mediums without drop-out or duplication.

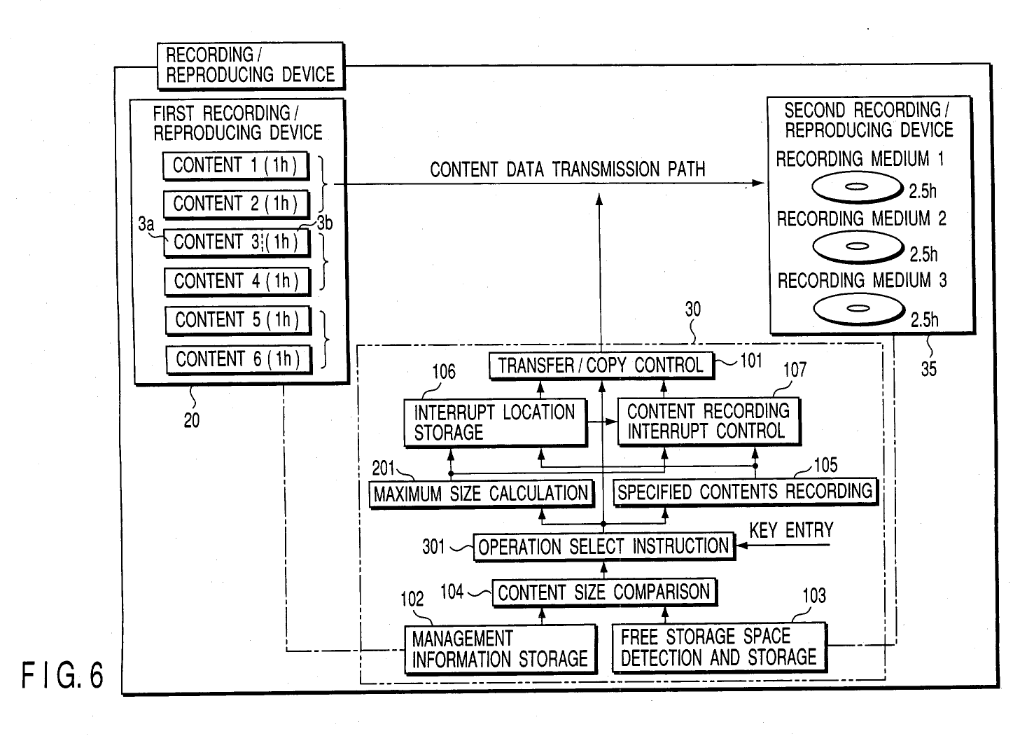

A third embodiment of the present invention will be described next with reference to FIG. 6, which is a block diagram of a recording/reproducing device of the third embodiment. An operation select instruction section 301 sets active the operation of either of the maximum size calculation section 201 and the specified contents recording section 105 in response to a key entry from the key entry unit 48 or the user I/F such as a remote control device. The functional blocks other than the operation select instruction section 301 operate in the same manner as in the above embodiments.

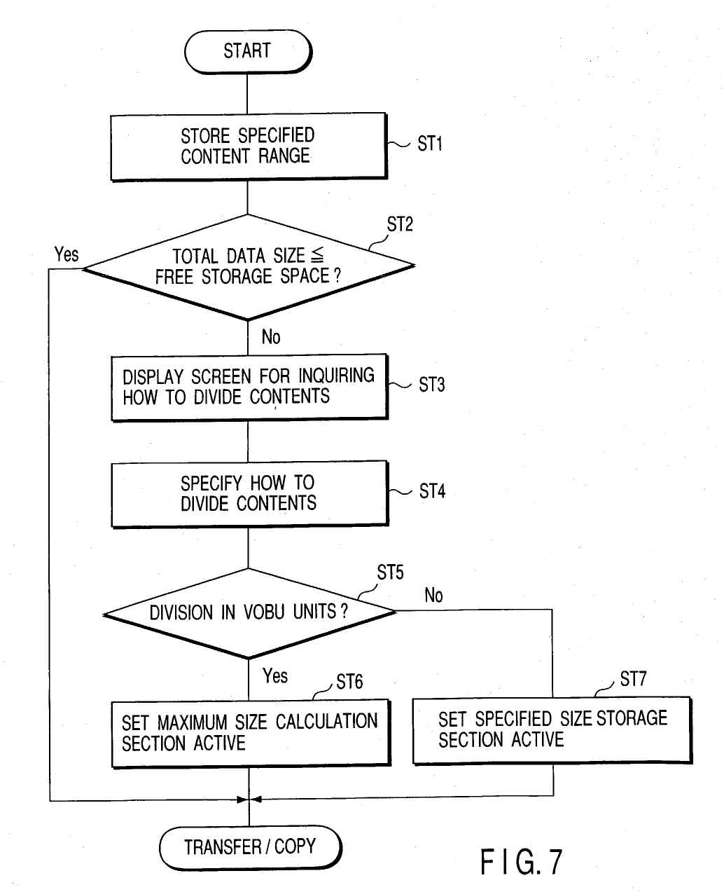

FIG. 7 is a flowchart illustrating the operation of the operation select instruction section 301.

When an instruction to transfer/copy one or more contents is given from the user I/F, the operation select instruction section 301 stores the range of the contents to be transferred/copied specified by the user into the RAM 30c. If the data size of the specified content range is smaller than the free space of a recording medium loaded into the second recording/reproducing unit 35 (YES in ST2), the operation select instruction section 301 instructs the transfer/copy control section 30 to start the transfer/copy of the contents. Thereby, the transfer/copy of the contents is started.

If the data size of the specified content range is larger than the free space of the recording medium (NO in ST2), the operation select instruction section 301 instructs the external display unit connected to the recording/reproducing device to display a screen for inquiring how the contents are to be divided (ST3). In response to the display screen, the user specifies how to divide the contents through the user I/F (ST4).

If the user specifies that the contents are to be divided in units of VOBUs (YES in ST5), the operation select instruction section 301 sets the maximum size calculation section 201 active (ST6) to instruct the transfer/copy control section to start the transfer/copy of the contents. Thereby, the transfer/copy of the contents is started.

If the user specifies that the contents are to be divided in content units (NO in ST5), the operation select instruction section 301 sets the specified contents recording section 105 active (ST7) to instruct the transfer/copy control section to start the transfer/copy of the contents. Thereby, the transfer/copy of the contents is started.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recording device comprising:
a first recording unit;
a second recording unit;
a transfer control section which controls a transferring operation of content data from the first recording unit to the second recording unit, the transferring operation including copying of the content data;
a free storage space detection section which detects and stores a free storage space of a recording medium in the second recording unit;
a size comparison section which, in specifying and transferring a plurality of contents from the first recording unit to the second recording unit, makes a comparison between a total data size of specified contents and the free storage space of the recording medium detected by the free storage space detection section; and
an instruction section which, when receiving from the size comparison section that the total data size of the specified contents is larger than the free storage space of the recording medium, instructs the transfer control section to record the specified contents onto a plurality of recording mediums in units of contents.

2. The recording device according to claim 1, further comprising a management information storage section which stores content management information including a record location and data size of each of contents recorded in the first recording unit, the instruction section instructs the transfer control section to record the specified contents onto a plurality of recording mediums in units of contents on the basis of the content management information stored in the management information storage section and the free storage space detected by the free storage space detection section.

3. The recording device according to claim 2, wherein the instruction section instructs the transfer control section to record continuously the specified contents onto a plurality of recording mediums in units of contents.

4. The recording device according to claim 2, wherein the instruction section includes:
a decision section which divides the plurality of contents in units of contents, decides a maximum number of contents, a size of which is smaller than or equal to the free storage space of the recording medium, and instructs the transfer control section to transfer the maximum number of contents onto a recording medium in the second recording unit,
a location storage section which reads and stores content management information for the maximum number of contents to be transferred onto the recording medium as instructed by the decision section, from the management information storage section, and
a recording resume control section which, when the recording medium is replaced with another recording medium in the second recording unit, instructs the transfer control section to resume the transfer of content data from the first recording unit to the second recording unit from a content to be played back subsequent to the contents already transferred.

5. The recording device according to claim 2, wherein the contents are video objects that conform to DVD standards.

6. The recording device according to claim 3, wherein the contents are video objects that conform to DVD standards.

7. A recording device comprising:
a first recording unit;
a second recording unit;
a transfer control section which controls a transferring operation of content data from the first recording unit to the second recording unit, the transferring operation including copying of the content data;
a management information storage section which stores content management information including a record location and data size of each of contents recorded in the first recording unit;
a free storage space detection section which detects and stores a free storage space of a recording medium in the second recording unit;
a size comparison section which, in specifying and transferring a plurality of contents from the first recording unit to the second recording unit, makes a comparison between a total data size of specified contents and the free storage space of the recording medium detected by the free storage space detection section; and
an instruction section which, when receiving from the size comparison section that the total data size of the specified contents is larger than the free storage space of the recording medium, instructs the transfer control section to record the specified contents onto a plurality of recording mediums in units of contents on the basis of the content management information stored in the management information storage section and the free storage space detected by the free storage space detection section.

8. The recording device according to claim 7, wherein the instruction section instructs the transfer control section to record continuously the specified contents onto a plurality of recording mediums in units of contents.

9. The recording device according to claim 7, wherein the instruction section includes:
a decision section which divides the plurality of contents in units of contents, decides a maximum number of contents, a size of which is smaller than or equal to the free storage space of the recording medium, and instructs the transfer control section to transfer the maximum number of contents onto a recording medium in the second recording unit,
a location storage section which reads and stores content management information for the maximum number of contents to be transferred onto the recording medium as instructed by the decision section, from the management information storage section, and
a recording resume control section which, when the recording medium is replaced with another recording medium in the second recording unit, instructs the transfer control section to resume the transfer of content data from the first recording unit to the second recording unit from a content to be played back subsequent to the contents already transferred.

10. The recording device according to claim 7, wherein the contents are video objects that conform to DVD standards.

11. The recording device according to claim 8, wherein the contents are video objects that conform to DVD standards.

12. A recording device comprising:
a first recording unit;
a second recording unit;
a transfer control section which controls a transferring operation of content data from the first recording unit to the second recording unit, the transferring operation including copying of the content data;
a management information storage section which stores content management information including a record location and data size of each of contents recorded in the first recording unit;
a free storage space detection section which detects and stores a free storage space of a recording medium in the second recording unit;
a size comparison section which, in specifying and transferring a content from the first recording unit to the second recording unit, makes a comparison between a data size of a specified content and the free storage space of the recording medium detected by the free storage space detection section; and
an instruction section which, when receiving from the size comparison section that the data size of the specified content is larger than the free storage space of the recording medium, instructs the transfer control section to record the specified content onto a plurality of recording mediums in units of data items each of which has a size smaller than that of the content, on the basis of the content management information stored in the management information storage section and the free space detected by the free storage space detection section.

13. The recording device according to claim 12, wherein the instruction section includes:
a maximum size calculation section which divides the content into plurality of video object units, calculates a maximum number of video object units which can be recorded onto the recording medium, and instructs the transfer control section to transfer the maximum number of video object units to the second recording unit,
a location storage section which reads and stores the record location in the first recording unit of the final one of the video object units to be transferred onto the second recording unit by the transfer control section, from the management information storage section, and
a recording resume control section which, when the recording medium is replaced with another recording medium in the second recording unit, instructs the transfer control section to resume the transfer of content data from the first recording unit to the second recording unit from a video object unit to be played back subsequent to the video object units already transferred.

14. The recording device according to claim 12, wherein the contents are video objects that conform to DVD standards.

15. The recording device according to claim 13, wherein the contents are video objects that conform to DVD standards.

16. A recording device comprising:
a first recording unit;
a second recording unit;
a transfer control section which controls a transferring operation of content data from the first recording unit to the second recording unit, the transferring operation including copying of the content data;
a management information storage section which stores content management information including a record location and data size of each of contents recorded in the first recording unit;
a free storage space detection section which detects and stores a free storage space of a recording medium in the second recording unit;
a size comparison section which, in specifying and transferring one or more contents from the first recording unit to the second recording unit, makes a comparison between a total data size of specified contents and the free storage space of the recording medium detected by the free storage space detection section;
a first instruction section which, when receiving from the size comparison section that the total data size of the specified contents is larger than the free storage space of the recording medium, instructs the transfer control section to record the specified contents onto a plurality of recording mediums in units of contents on the basis of the content management information stored in the management information storage section and the free storage space detected by the free storage space detection section;
a second instruction section which, when receiving from the size comparison section that the data size of the specified contents is larger than the free storage space of the recording medium, instructs the transfer control section to record the specified contents onto a plurality of recording mediums in units of data items each of which has a size smaller than that of the content, on the basis of the content management information stored in the management information storage section and the free space detected by the free storage space detection section; and
an operation selection section which selectively operates one of the first and second instruction section.

17. The recording device according to claim 16, wherein the first and second instruction sections instruct the transfer control section to record continuously the specified contents onto a plurality of recording mediums.

18. A recording method for use with a recording device comprising a first recording unit, a second recording unit, and a transfer control section controlling transferring operation of content data from the first recording unit to the second recording unit, the transferring operation including copying of the content data, the recording method comprising:
storing content management information including a record location and data size of each of contents recorded in the first recording unit;
detecting and storing a free storage space of a recording medium in the second recording unit;
in specifying and transferring content from the first recording unit to the recording unit, making a comparison between a data size of a specified content and the free storage space of the recording medium; and
when the data size of the specified content is larger than the free storage space of the recording medium, instructing the transfer control section to record continuously the specified content onto a plurality of recording mediums, on the basis of the content management information and the free storage space.

19. The method according to claim 18, wherein the instructing includes instructing the transfer control section to record continuously the specified contents onto a plurality of recording mediums in units of contents.
